(19) United States
(12) Patent Application Publication
(10) Pub. No.: US 2024/0105153 A1
(43) Pub. Date: Mar. 28, 2024

(54) OUTPUT CONTROL METHOD, ELECTRONIC DEVICE, AND RECORDING MEDIUM

(71) Applicant: CASIO COMPUTER CO., LTD., Tokyo (JP)

(72) Inventor: Jun SATO, Tokyo (JP)

(73) Assignee: CASIO COMPUTER CO., LTD., Tokyo (JP)

(21) Appl. No.: 18/241,445

(22) Filed: Sep. 1, 2023

(30) Foreign Application Priority Data
Sep. 22, 2022 (JP) 2022-150796

(51) Int. Cl. G10H 1/00

(52) U.S. Cl. CPC G10H 1/0066; G10H 1/0008; G10H 2240/311

(57) ABSTRACT

An electronic device includes at least one processor that outputs an output signal in response to acquisition of information data with which information on output timing is associated with respect to each unit data. The at least one processor is configured to perform control of outputting the output signal in accordance with the unit data, at delayed timing after a lapse of a certain delay setting time period from the output timing, and if output of the output signal is further delayed from the delayed timing, extend the delay setting time period in accordance with a duration of the further delay.

### REFERENCE TO RELATED APPLICATIONS

This application is based upon and claims the benefit of priority from the prior Japanese Patent Application No. 2022-150796, filed on Sep. 22, 2022, the entire contents of which are incorporated herein by reference.

### TECHNICAL FIELD

The present invention relates to an output control method, an electronic device, and a recording medium.

### DESCRIPTION OF THE RELATED ART

Conventionally, MIDI (Musical Instrument Digital Interface) has been widely used for musical performance data that defines the content of an electronic musical performances. When MIDI data is input into an audio output circuit, an audio signal is generated from the MIDI data. By outputting the audio signal to a speaker or an audio output terminal (including a headphone terminal etc.), a musical performance according to content designated by musical performance data is output as a sound.

When the MIDI data is output to the audio output circuit through wireless communication, a delay sometimes occurs, and it is difficult to output the sound in real time. To address this, JP 2003-345350A discloses a technique that outputs a sound at timing obtained by adding a prescribed delay time period to time assigned to each transmission packet of MIDI data. The delay time period is confined in a range without causing users' acoustic discomfort, thus allowing audio output even in case a communication delay shorter than the delay time period occurs.

### SUMMARY OF THE INVENTION

One of advantages of this disclosure is to provide an output control method, an electronic device, and a recording medium that are capable of adjusting the delay of output more flexibly.

To achieve the advantage described above, an electronic device according to this disclosure includes at least one processor that outputs an output signal in response to acquisition of information data with which information on output timing is associated with respect to each unit data, wherein the at least one processor is configured to, perform control of outputting the output signal in accordance with the unit data, at delayed timing after a lapse of a certain delay setting time period from the output timing, and if output of the output signal is further delayed from the delayed timing, extend the delay setting time period in accordance with a duration of the further delay.

### BRIEF DESCRIPTION OF THE DRAWINGS

FIG. 1 is a block diagram illustrating a functional configuration of an electronic device.

FIG. 2A illustrates timings of MIDI data transmission and reception, and of outputting an output signal.

FIG. 2B illustrates an output timing of the output signal in a case where a data reception timing is after an assumed output timing.

FIG. 3 is a flowchart illustrating control procedures of an audio output control process.

FIG. 4 is a flowchart illustrating control procedures of an output timing setting process.

### DETAILED DESCRIPTION

Hereinafter, an embodiment of this disclosure is described with reference to the drawings.

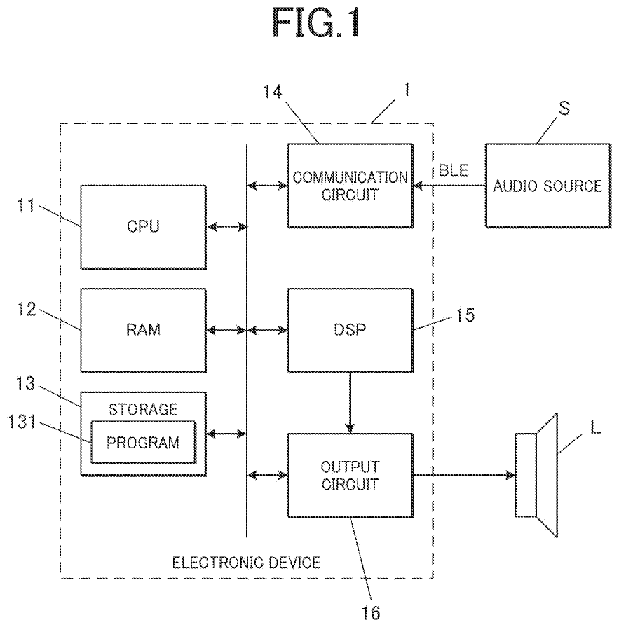

FIG. 1 is a block diagram illustrating a functional configuration of an electronic device 1 in this embodiment.

The electronic device 1 analyzes musical performance data (information data), e.g., MIDI data, received from an audio source S, and generates audio output data that includes at least any of a musical tone and a sound. The electronic device 1 applies analog conversion to the generated audio output data, and generates and outputs an audio output signal (output signal). The audio source S may be a typical computer (PC) (in which MIDI software or the like is installed) or the like. Alternatively, the audio source S may be an electronic musical instrument or the like, in which musical performance content is converted into MIDI datatored, and output. The output destination of the audio output signal is, for example, a speaker L, earphones, headphones, an electronic device that records the audio output signal.

The electronic device 1 includes a CPU (Central Processing Unit) 11 as at least one processor, a RAM (Random access Memory) 12, a storage 13, a communicator (communication circuit) 14, a DSP (Digital Signal Processor) 15 as at least one processor, and an output circuit 16. These components are electrically connected to each other via a bus.

The CPU 11 is a processor that performs a computational process, and integrally controls the operation of the electronic device 1. The CPU 11 may be what is designed suitably for control of generating the audio output data. The CPU 11 may have a single processor, or a plurality of processors that operate in parallel, or independently for the respective purposes. The CPU 11 counts the current time, based on a clock signal output by an oscillator circuit, not illustrated. To achieve this, the electronic device 1 includes an RTC (Real Time Clock), not illustrated. The CPU 11 acquires the current time from the RTC when the electronic device 1 is activated.

The RAM 12 provides the CPU 11 with a working memory space, and stores temporary data. The temporary data includes MIDI data input from the outside.

The storage 13 is a nonvolatile memory, and is, for example, a flash memory or an HDD. The storage 13 stores a program 131 pertaining to generation of the audio output data, and setting data.

The communicator 14 controls operation of communication with an external device in conformity with a defined communication standard. Here, the communication standard usable for communication may be Bluetooth® Low Energy (BLE) or the like.

The DSP 15 is a dedicated circuit that analyzes MIDI data, and generates audio output data. The generated audio output data is output to the output circuit 16. The DSP 15 can simultaneously process an upper limit number of MIDI data in parallel, generate respective audio data, and generate audio output data obtained by combining these data through a mixer. The processes of the DSP 15 may include an effect process for the output sound.

The output circuit 16 includes, a DAC (digital/analog converter) that applies analog conversion to the audio output data generated by the DSP 15, and an output terminal for outputting, to the outside, an analog audio output signal obtained by the analog conversion. The output circuit 16 may include an amplifier that amplifies the audio output signal. The electronic device 1 itself may include the speaker L.

The electronic device 1 may separately include an input terminal for accepting musical performance data (audio data) from an electronic musical instrument. The musical performance data can be input into the DSP 15, combined with audio data based on MIDI data, and transmitted to the output circuit 16.

The electronic device 1 may include, an operation receiver that includes an operation button for turning on and off power supply, and a display that includes a display screen for displaying a status and the like.

Next, acquisition of MIDI data, and audio output are described.

The MIDI data includes information indicating the content of a sound to be output (pitch, tone, intensity and the like, and changes with passage of time (rising characteristics of accents and the like, reduction in sound volume, and a frequency spectrum distribution)).

The electronic device 1 can receive (acquire) MIDI data from an external device through BLE (wireless communication). According to BLE, data is sent in units of packets that are transmitted in a prescribed communication interval (certain time interval). The setting of the communication interval can be changed in a range defined by the BLE standard. However, the setting is often fixed (e.g., an interval of 15 msec). In this embodiment, description is made assuming that packet data is transmitted and received at a uniform communication interval. The data format of communication content may comply with a common standard (MIDI over Bluetooth Low Energy). Each packet includes one or more data that each include a certain piece of content (a message, or a unit data) of the MIDI data, and information on the output timing (time stamp) associated with the piece of content. The associated output timings may be identical or close to each other in a range of allowing parallel processing by the DSP 15, with respect to multiple messages.

In wireless communication, such as of BLE, a time period required to transmit and receive data is sometimes, temporarily changed (extended) by a communication delay, change in amount of data and the like. When the audio output signal generated from the content of the received MIDI data and analog-converted is output in real time, the audio output timing can fluctuate with change in time period required for such communication. The electronic device 1 more correctly aligns the sound output timing in accordance with the output timing information described above.

In a case with a large number of settings of audio content output in a packet data transmission interval, a single packet cannot include entire output content, and the content is sometimes divided into multiple packets. In a case of data defined so as to finely cause a large number of sounds, the amount of data per unit time period of a musical performance (e.g., about a packet transmission interval) is prone to increase. Accordingly, if required content cannot entirely be received and acquired until the audio output timing, correct audio output cannot be made as a result, and part of the sound is emitted in a delayed manner.

The electronic device 1 further sets a delay setting time period in addition to the output timing information described above, and uniformly puts off the audio output timing, from the designated output timing, by each delay setting time period. If the MIDI data including the entire audio output content pertaining to the output timing is received in the delay setting time period, the audio output data corresponding to the received content is generated, and a sound in accordance with the MIDI data is output. In the electronic device 1, the MIDI data is output to the DSP 15 at timing after a lapse of the delay setting time period from the output timing, and the audio output data is generated by the DSP 15. The audio output data is further sent to the output circuit 16, and is subjected to analog conversion, thus allowing the audio output signal to be obtained. These DSP 15 and output circuit 16 constitute a signal processor in this embodiment. The processes of the DSP 15 and the output circuit 16 are included in an audio output signal generation process in this embodiment.

On the other hand, if the delay setting time period is too long, a time lag to output from input timing cannot be ignored, and sensory discomfort occurs in a user. Consequently, it is preferable to set the delay setting time period short in a range allowing audio output based on the MIDI data to be correctly performed.

It is conceivable that such a delay setting time period is designated by the user (including a case of designating the delay setting time period in the MIDI data). However, it is not easy to strictly adjust the delay setting time period in consideration of the amount of the MIDI data per unit time period. In consideration of certainty, the delay setting time period is prone to be longer than what is required.

In the electronic device 1 in this embodiment, the delay setting time period is set to have an initial setting value at start of reception of the MIDI data. If the output of the audio output signal is delayed from the output timing, and the setting of the delay setting time period, the setting is changed so that subsequent delay setting time periods can each be extended by the amount of delay. In other words, the electronic device 1 permits an audio output deviation, only in a case where a delay exceeding a certain delay setting time period occurs with reference to this delay setting time period, thus sequentially performing adjustment.

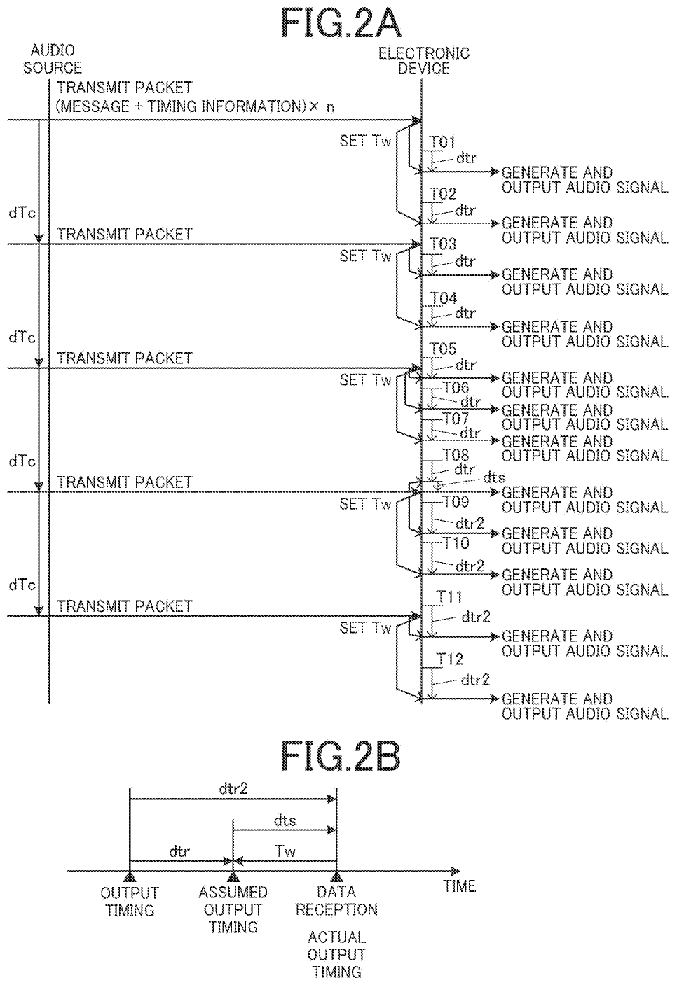

FIG. 2A is a sequence diagram illustrating the timings of MIDI data transmission and reception, and of outputting the audio output signal. Note that this diagram is schematic for illustration. The actual amount of data, the output frequency of the audio output signal and the like are not reflected in the diagram. Note that the deviation between the timing of transmitting the packet from the audio source (external device) and the timing of receiving the packet data at the electronic device 1 is substantially constant, and is a short time period. Accordingly, the deviation is ignored here.

The packet data of the MIDI data is transmitted from the audio source at a time interval dTc. Each of n messages in the packet is assigned output timing information. This assignment may be in any form provided that the output timing can be uniquely identified even if the timing is not clearly indicated in conformity with the format. The output timing information is, for example, a counter value that makes a complete revolution at a certain temporal period. Although not specifically limited, a temporal period Tp is sufficiently longer than a period reaching a sound interval that can occur in a typical piece of music, and is, for example, about eight seconds. Information on the length of one period is preliminarily held also in the electronic device 1.

Upon receipt of the packet data, the electronic device 1 acquires the output timing of data on a message-by-message basis, and associates the timing with the current time counted by the CPU 11. The reference of association may be freely defined. For example, the value of the output timing assigned to the leading message of the initially received packet data may be associated with the current time at this occasion. Based on the setting time of audio output, the current time, and the delay setting time period that have been obtained as described above, the audio output data is generated from the message, and a time period until output of the audio output signal is set. For example, in the initial packet transmission, the packet data includes messages to be audio-output at timings T01 and T02. Based on the set delay setting time period dtr, each standby setting time period Tw from data reception to generation and output of the audio signal is set.

The standby setting time period Tw can be obtained as in the following Expression (1), with the timing Tk acquired this time, current time U, reference timing TB, reference time UB, delay setting time period dtr, and temporal period Tp of the counter value indicating the timing.

Tw=(Tk+n×Tp−TB)−(U−UB)+dtr (1)

A variable n is an integer of zero or more, and is incremented by one when the value of the timing Tk becomes smaller than the timing T(k−1) at the last time. Accordingly, the first term on the right-hand side represents a time period from the reference timing TB to the output timing this time. A value obtained by adding the reference time UB to the first term on the right-hand side is the time Uk at the timing Tk. A value obtained by adding the delay setting time period dtr to the time Uk is identified as the setting time of the actual output timing. By subtracting the current time U from the setting time, the standby setting time period Tw from the current time U to the output timing is obtained. In actual calculation, as indicated by Expression (1), a difference (time period) between the current time U and the reference time UB may be obtained first, and this difference may be subtracted from the sum of the first term on the right-hand side and the delay setting time period dtr.

The second packet transmission includes messages to be audio-output at timings T03 and T04. The third packet transmission includes messages to be audio-output at timings T05 to T07. The third packet transmission has an increased amount of data transmission in comparison with the second packet transmission.

The fourth packet transmission includes messages to be audio-output at timings T08 to T10. However, the data reception timing has already exceeded the timing after a lapse of the delay setting time period dtr from timing T08. In this case, the obtained standby setting time period Tw has a negative value. The magnitude of the negative value (absolute value) is determined as a time difference dts (duration). Audio data in accordance with the content of the message is immediately generated, and is output with the deviation of the time difference dts from other normal audio output.

FIG. 2B illustrates in detail a case where the data reception timing is after an assumed output timing at which audio output is originally assumed to be made. The output timing assigned to message data is temporally before the data reception timing. The assumed output timing (delayed timing) after the lapse of the delay setting time period dtr from the output timing is also before the data reception timing.

In this case, at the data reception timing, the audio data is immediately generated and analog-converted, and a data output signal is output (actual output timing). The time difference dts representing the delay of output at this time is obtained by inverting the sign of the calculated standby setting time period Tw (negative value). In a case where such situations occur, a corrected delay setting time period is obtained by adding the time difference dts to the uncorrected delay setting time period dtr (subtracting the standby setting time period Tw).

In generation of the audio output data at and after the timing T09, a new delay setting time period dtr2 is set. The delay setting time period dtr2 is set to a time difference between the timing T08 and the actual audio output timing. That is, the delay setting time period dtr2 is obtained by adding the time difference dts to the uncorrected delay setting time period dtr.

Audio output signals corresponding to messages that are transmitted by the fifth packet transmission and are to be audio-output at timings T11 and T12 are generated and output also with the new delay setting time period dtr2 described above.

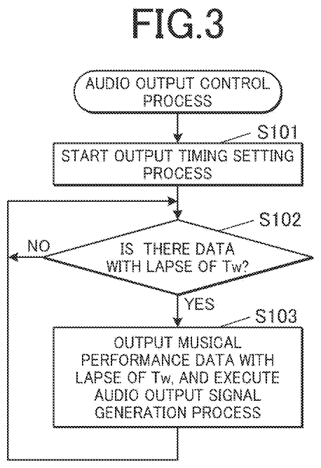

FIG. 3 is a flowchart illustrating control procedures by the CPU 11 that are of an audio output control process executed in the electronic device 1 in this embodiment. The audio output control process that is an output control method in this embodiment is started at activation of the electronic device 1 and is continuously in execution, for example.

The CPU 11 starts an output timing setting process described later (step S101). The CPU 11 determines whether or not there is message data with the lapse of the standby setting time period Tw set by the output timing setting process described later (at the delayed timing) (step S102). As described later, the standby setting time period Tw is a difference between time of obtaining the message data, and time after the lapse of the delay setting time period dtr from time pertaining to the output timing associated with the message data. If it is determined that there is no message data with the lapse of the standby setting time period Tw (“NO” in step S102), the CPU 11 repeats the process of step S102.

If it is determined that there is message data with the lapse of the standby setting time period Tw (“YES” in step S102), the CPU 11 outputs the message data to the DSP 15 (step S103). Accordingly, The CPU 11 causes the DSP 15 and the output circuit 16 to execute the audio output signal generation process. That is, the DSP 15 generates the audio output data based on the message data, and outputs the data to the output circuit 16. The output circuit 16 applies analog conversion to the data, and outputs the converted data as an audio output signal. If there are a plurality of applicable message data, the CPU 11 inputs them into the DSP 15 in parallel, and generates respective audio data in parallel. The processing of the CPU 11 returns to step S102.

The processes of steps S102 and S103 constitute an output controller of the program 131 in this embodiment.

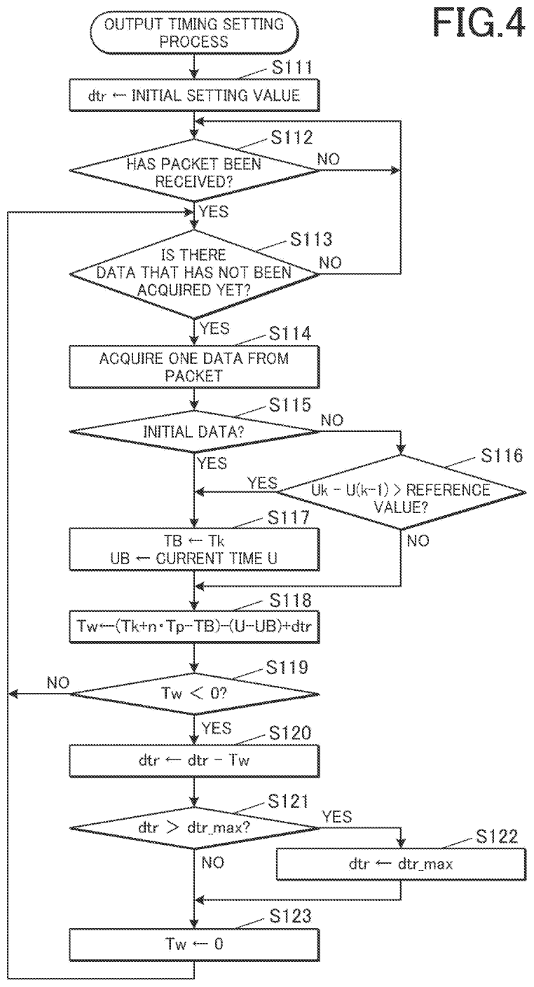

FIG. 4 is a flowchart illustrating control procedures by the CPU 11 that are of the output timing setting process starting in step S101 in FIG. 3. The output timing setting process is activated, and subsequently, is executed in parallel with the audio output control process.

The CPU 11 sets the delay setting time period dtr to an initial setting value (step S111). The initial setting value is a value that the electronic device 1 preliminarily has. Alternatively, the initial setting value may be a value accepted by an input operation or the like made by the user through the operation receiver, not illustrated, or the delay setting time period lastly set in the immediately previous time may be stored in the storage 13 and then used.

The CPU 11 determines whether the communicator 14 has received the packet data through BLE or not (step S112). If it is determined that the packet data has not been received (“NO” in step S112), the CPU 11 repeats the process of step S112.

If it is determined that the packet data has been received (“YES” in step S112), the CPU 11 determines whether or not the received packet data includes message data that has not been acquired yet (step S113). If it is determined that there is no message data that has not been acquired yet (“NO” in step S113), the processing of the CPU 11 returns to step S112.

If it is determined that there is message data that has not been acquired yet (“YES” in step S113), the CPU 11 acquires one message data from the packet data (step S114).

The CPU 11 determines whether or not the acquired data is the initial data on the musical performance (step S115). If it is determined. that the data is the initial data (“YES” in step S115), the processing of the CPU 11 transitions to step S117.

If it is determined that the acquired data is not the initial data (“NO” in step S115), the CPU 11 determines whether or not the timing Tk assigned to the message data acquired this time is subsequent to the last timing T(k−1) by one period or more that is the temporal period of the counter value (step S116). The CPU 11 determines whether or not the current time is advanced by about the one period from the time U(k−1) associated with the timing T(k−1) of the message data acquired last time, and it is assumed that audio output within one period from the time described above is designated. Accordingly, the CPU 11 stores, in the RAM 12, the last one of times Uk at the output timings that have been calculated so far. The CPU 11 determines whether or not the difference between the current time U and the time Uk is larger than a reference value of about the temporal period Tp (e.g., a time period shorter than the temporal period Tp by several periods that are time intervals dTc pertaining to the packet data transmission). If it is determined that the difference between The current time U and the time Uk is larger than the reference value (“YES” in step S116), the processing of the CPU 11 transitions to step S117. Note that before transition to the process of step S117, the CPU 11 may perform the same process as that of step S111, and initialize the delay setting time period dtr. If it is determined that the difference between the current time U and the time Uk is not larger than the reference value (less than the reference value) (“NO” in step S116), the processing of the CPU 11 transitions to step S118.

After transition to the process of step S117, the CPU 11 sets the timing Tk acquired this time, as the reference timing TB, and sets the current time U as the reference time UB corresponding to the reference timing TB (step S117). The processing of the CPU 11 transitions to step S118.

After transition to the process of step S118, the CPU 11 acquires the current time U, and calculates the standby setting time period Tw until execution of the process of generating the audio signal, from the message data this time, according to the expression described above (step S118).

The CPU 11 determines whether or not the standby setting time period Tw is less than zero (negative value) (step S119). If it is determined that the standby setting time period Tw is not less than zero (zero or higher) (“NO” in step S119), the processing of the CPU 11 returns to step S113.

If it is determined that the standby setting time period Tw is less than zero (has a negative value) (“YES” in step S119), the CPU 11 subtracts the standby setting time period Tw from the current delay setting time period dtr (step S120). That is, the CPU 11 increases (extends) the delay setting time period dtr by the delay of generation and output of the audio signal.

The processes of steps S119 and S120 constitute an extension controller in the program 131 in this embodiment.

The CPU 11 determines whether or not the obtained delay setting time period dtr is longer than a predetermined maximum setting value dtr_max (maximum setting time period) of the delay setting time period (step S121). If it is determined that the delay setting time period dtr is longer than the maximum setting value dtr_max (“YES” in step S121), the CPU 11 sets the delay setting time period dtr to the maximum setting value dtr_max (step S122). The processing of the CPU 11 transitions to step S123. If it is determined that the delay setting time period dtr is not longer than the maximum setting value dtr_max (equal to or less than the maximum setting value dtr_max) (“NO” in step S121), the processing of the CPU 11 transitions to step S123.

After transition to the process of step S123, the CPU 11 sets the standby setting time period Tw to zero (step S123). The processing of the CPU 11 returns to step S113.

As described above, the output control method in this embodiment outputs the audio output signal in accordance with the message data, at the delayed timing after the lapse of the certain delay setting time period dtr from the output timing, in response to acquisition of the MIDI data with which information on the output timing is associated on a message-by-message basis in the packet. If output of the audio output signal is further delayed from the delayed timing, the delay setting time period dtr is extended by the time difference dts of the further delay.

That is, if situations occur where the musical performance output is not made in time with respect to the appropriate timing according to the actual MIDI data, the subsequent delay setting time periods dtr are sequentially extended in accordance with the degree of the delay. As described above, the electronic device 1 sets the delay setting time period more flexibly and appropriately. Accordingly, the electronic device 1 does not extend the delay setting time period dtr longer than what is required, and can reduce the frequency of occurrence of incorrect audio output of the musical performance at the same time.

If the output of the audio output signal in accordance with a certain message data is further delayed from the delayed timing, the delay setting time period dtr pertaining to the output timing of the audio output signal in accordance with each of message data after this message data is set to a delay setting time period extended in accordance with the time difference dts.

As described above, for the message data after the data where the time difference dts occurs, the time difference dts is reflected in the delay setting time period dtr. Accordingly, the delay setting time period dtr can be extended quickly to what is at a level of the actually occurring delay time period. Consequently, according to the output control method, subsequent output does not tend to be delayed longer than the setting.

The output control method acquires the MIDI data together with one or more message data, i.e., at the time interval dTc with respect to each packet data. In the case where the time interval dTc is set for the packet data transmission and reception as described above, a case is prone to occur where not the entire information required to correct audio output can be acquired in time. The output control method in this embodiment adjusts the delay setting time period dtr while detecting such a case in real time. Consequently, according to the output control method, the user preliminarily measures and predicts the amount of data in each temporal range of a piece of music, which can omit procedures and the like of defining the delay setting time period dtr.

The MIDI data may include a plurality of message data assigned the same output timing information. According to the MIDI data, multiple sounds can be output at the same time. Consequently, these may be included in multiple messages different from each other. Due to the limitation on the packet capacity, at an audio output portion having a large amount of datauch message data may be included in packets different from each other. In this case, the output control method described above cannot correctly perform audio output unless all the data in the different multiple packets are received. Consequently, it is important to set the delay setting time period dtr for correct audio output. Therefore, the output control method in this embodiment flexibly changes the delay setting time period dtr, which can suppress incorrect audio output and increase in unnecessary time lag.

The output control method in this embodiment generates and outputs the audio output signal in accordance with the message data at the delayed timing. That is, the generation itself of the audio output signal is suspended until the delayed timing. Accordingly, the output control method can generate each audio data after all the required message data are received, and obtain an appropriately mixed audio output signal.

The output control method defines the maximum setting value dtr_max of the delay setting time period dtr. If output of the audio output signal is largely delayed from the output timing by the maximum setting value dtr_max or more, the delay setting time period dtr can be set to be equal to or less than the maximum setting value dtr_max. For example, the delay setting time period dtr can be made equal to the maximum setting value dtr_max. As described above, the delay setting time period dtr is not increased unlimitedly. Accordingly, the time lag between input of the musical performance data and output of the audio output signal can be appropriately confined within a range causing no problem for the user and the like.

The delay setting time period dtr is set to the initial setting value at the start of receiving the MIDI data. The delay setting time period dtr can have a required value that varies depending on pieces of music. Consequently, the output control method in this embodiment resets the delay setting time period dtr to the initial value again with respect to each musical performance, thus allowing an appropriate time period to be set with respect to each piece of music.

In response to acquisition of the MIDI data assigned the information on the output timing with respect to each message data, the program 131 in this embodiment causes the computer (electronic device 1) outputting the audio output signal, to function as: the output controller that performs control of outputting the audio output signal in accordance with the message data at the delayed timing after the lapse of a certain delay setting time period dtr from the output timing; and the extension controller that extends the delay setting time period dtr in accordance with the time difference dts of the delay if output of the audio output signal is further delayed from the delayed timing.

The program 131 that executes the process pertaining to this output control method described above is easily installed in the computer and executed. Accordingly, even without complicated hardware setting or the like, the delay setting time period dtr can be set easily and flexibly. Consequently, this program 131 can suppress disturbance of the audio output due to the delay of receiving the message data, and the user's discomfort due to increase in the time lag, in an effective and balanced manner.

The electronic device 1 in this embodiment includes: the DSP 15 and the output circuit 16 that serve as the signal processor that outputs the audio output signal in response to acquisition of the MIDI data with which the information on the output timing is associated with respect to each message data; and the CPU 11. The CPU 11 performs control of outputting the audio output signal accordance with the message data, at the delayed timing after a lapse of a certain delay setting time period dtr from the output timing. If output of the audio output signal is further delayed from the delayed timing, the CPU 11 extends the delay setting time period dtr by the time difference dts of the further delay.

In the conventional art, in case a communication delay longer than the set delay time period occurs, the output circuit stops the musical performance at the time. Accordingly, it is difficult for the output circuit to flexibly set the delay time period to be short. As described above, in this disclosure, in case of occurrence of situations where actual musical performance output cannot be made in time at appropriate timing set in the MIDI data, the delay setting time period dtr is sequentially extended in accordance with the degree. As described above, the electronic device 1 can set the delay setting time period more flexibly and appropriately. Accordingly, the electronic device 1 does not excessively extend the delay setting time period dtr longer than what is required, and can reduce the frequency of occurrence of incorrect audio output, at the same time.

Note that the present invention is not limited to the embodiment described above, and can be variously changed.

For example, according to the aforementioned embodiment, the description is made where the delay setting time period dtr is extended by the length identical to the time difference dts of delay of the audio output. However, there is no limitation to this. For example, the delay setting time period dtr may be extended by a duration obtained by multiplying a certain coefficient slightly larger than one to the time difference dts. Alternatively, the delay setting time period dtr may be extended by a duration obtained by adding a uniform added extension duration to the time difference dts.

In the aforementioned embodiment, the description is made where the audio output data (digital data) is generated immediately before (substantially simultaneously) generation of the audio output signal (analog conversion). There is no limitation to this. For example, the preliminarily generated audio output data may once be stored in a buffer, and the output circuit 16 may convert (generate) the stored audio output data into the audio output signal at appropriate timing or at timing after a lapse of a specific time period.

In the aforementioned embodiment, the description is made where the MIDI data is transmitted to the electronic device 1 through BLE. However, there is no limitation to this. The MIDI data may be acquired in conformity with another communication standard that allows the electronic device 1 to achieve acquisition. The communication interval in this case is not necessarily constant. Also in the case of BLE, the communication interval may be variable.

The musical performance data received by the electronic device 1 may conform to any data format.

The determination of whether the delay setting time period exceeds the maximum setting value dtr_max or not is not limited to that in the process described above. For example, comparison may be made before the negative standby setting time period Tw is actually subtracted from the delay setting time period dtr. If possible subtraction of the standby setting time period Tw causes the delay setting time period dtr to exceed the maximum setting value dtr_max, the process itself of subtracting the standby setting time period Tw may be stopped.

In the aforementioned embodiment, the description is made where the CPU 11 controls the process of generating the audio output data by the DSP 15. However, there is no limitation to this. The CPU 11 itself may perform the process of generating the audio output data through software. That is, the signal processor in this embodiment may be the CPU 11.

The output timing of the audio output signal at the delayed timing is not necessarily controlled by the CPU 11. For example, the output circuit 16 may control the output timing, and the CPU 11 may monitor the timing, and only perform a process of changing and setting the delay setting time period dtr.

The determination condition in step S116 pertaining to the initialization of the delay setting time period dtr may be different from that in the above description. For example, the difference from the current time U is not necessarily from the time Uk at the closest timing Tk, and may be obtained as the difference from the current time obtained in step S118 last time. Alternatively, if a reset operation made by an input operation by the user through the operation receiver, not illustrated, is accepted, the delay setting time period dtr may be initialized. The delay setting time period dtr may be initialized in a case where a state in which there is no data that has not been acquired yet continues for a prescribed time period or longer in step S113, instead of the case after the process of step S116.

The embodiment described above is for output control on the data pertaining to the sound. Alternatively, this can be used for output control of data (information data) pertaining to information other than that on the sound.

In the above description, the storage 13 made up of a non-volatile memory, such as a flash memory, is exemplified as a computer-readable medium that stores the program 131 according to the output control this disclosure. However, there is no limitation to them. Another applicable computer-readable medium may be any of another non-volatile memory, such as an MRAM, an HDD (Hard Disk Drive), and portable recording media, such as a CD-ROM and a DVD disk. Carrier waves are also applicable, to this disclosure, as a medium of providing data on the program according to this disclosure via a communication line.

Furthermore, the specific configuration, the content and procedures of the processing operation and the like described in the aforementioned embodiment can be appropriately changed in a range without departing from the spirit of the present invention. The scope of the present invention encompasses the scope of the invention described in the claims and the range of equivalence of the scope.

1. An output control method performed in an electronic device including at least one processor, the at least one processor configured to perform the method comprising:
controlling of outputting an output signal in accordance with unit data, at delayed timing after a lapse of a certain delay setting time period from output timing, in response to acquisition of information data with which information on the output timing is associated with respect to each unit data; and
if output of the output signal is further delayed from the delayed timing, extending the delay setting time period in accordance with a duration of the further delay.

2. The output control method of the electronic device according to claim 1, wherein if the output of the output signal in accordance with the certain unit data is further delayed from the delayed timing, the processor sets the delay setting time period pertaining to the output timing of the output signal accordance with each of the unit data after the certain unit data, to a delay setting time period extended in accordance with the duration.

3. The output control method of the electronic device according to claim 1, wherein each of the information data is acquired at a certain time interval for one or a plurality of the unit data.

4. The output control method of the electronic device according to claim 1, wherein the information data includes a plurality of the unit data assigned identical output timing information.

5. The output control method of the electronic device according to claim 1, wherein the at least one processor performs control of generating and outputting the output signal is accordance with the unit data at the delayed timing.

6. The output control method of the electronic device according to claim 1, wherein,
a maximum setting time period of the delay setting time period is defined, and
if the output of the output signal is largely delayed from the output timing by a time period longer than the maximum setting time period, the at least one processor sets the delay setting time period to be equal to or shorter than the maximum setting time period.

7. The output control method of the electronic device according to claim 1, wherein the at least one processor sets the delay setting time period to an initial setting value at start of reception of the information data.

8. An electronic device, comprising:
at least one processor that outputs an output signal in response to acquisition of information data with which information on output timing is associated with respect to each unit data,
wherein the at least one processor is configured to,
perform control of outputting the output signal in accordance with the unit data, at delayed timing after a lapse of a certain delay setting time period from the output timing, and
if output of the output signal is further delayed from the delayed timing, extend the delay setting time period in accordance with a duration of the further delay.

9. The electronic device according to claim 8, wherein if the output of the output signal in accordance with the certain unit data is further delayed from the delayed timing, the processor sets the delay setting time period pertaining to the output timing of the output signal in accordance with each of unit data after the certain unit data, to a delay setting time period extended is accordance with the duration.

10. The electronic device according to claim 8, wherein each of the information data is acquired at a certain time interval for one or a plurality of the unit data.

11. The electronic device according to claim 8, wherein the information data includes a plurality of the unit data assigned identical output timing information.

12. The electronic device according to claim 8, wherein the at least one processor performs control of generating and outputting the output signal in accordance with the unit data at the delayed timing.

13. The electronic device according to claim 8, wherein,
a maximum setting time period of the delay setting time period is defined, and
if the output of the output signal is largely delayed from the output timing by a time period longer than the maximum setting time period, the at least one processor sets the delay setting time period to be equal to or shorter than the maximum setting time period.

14. The electronic device according to claim 8, wherein the at least one processor sets the delay setting time period to an initial setting value at start of reception of the information data.

15. A non-transitory recording medium storing a program causing a computer of an electronic device that outputs an output signal in response to acquisition of information data with which information on output timing is associated with respect to each unit data, to:
perform control of outputting the output signal in accordance with the unit data, at delayed timing after a lapse of a certain delay setting time period from the output timing; and
if output of the output signal is further delayed from the delayed timing, extend the delay setting time period in accordance with a duration of the further delay.
